(19) United States
(12) Patent Application Publication
(10) Pub. No.: US 2019/0160561 A1
(43) Pub. Date: May 30, 2019

(54) BULL MILL CUTTER

(71) Applicant: JI ZHUN PRECISION INDUSTRY (HUI ZHOU) CO., LTD., Huizhou (CN)

(72) Inventors: LONG XU, Shenzhen (CN); YI-MIN JIANG, Shenzhen (CN); JUN-QI LI, Shenzhen (CN)

(21) Appl. No.: 16/243,392

(22) Filed: Jan. 9, 2019

(30) Foreign Application Priority Data
Sep. 27, 2018 (CN) 201811133367.5

(51) Int. Cl. B23C 5/10

(52) U.S. Cl. CPC B23C 5/1009; B23C 2210/32; B23C 2226/18; B23C 2226/125; B23C 2226/31

(57) ABSTRACT

A bull mill cutter includes a cutter bar and a cutter head. The cutter head has one end mounted to the cutter bar. The cutter head includes a main body and a number of cutter teeth mounted on the main body. A quantity of the cutter teeth is equal to a positive integer within a range from 8 to D*15. D is equal to a diameter of the main body of the cutter head in millimeters.

### FIELD

The subject matter herein generally relates to cutter teeth, and more particularly to a bull mill cutter.

### BACKGROUND

Cutting devices for processing hard materials having high fragility, such as graphite, ceramic, glass, carbon fiber, and hard alloy, generally use diamond blades. However, cutting devices in use generally have a low number of blades which results in course processing and a low life of the cutting device.

### BRIEF DESCRIPTION OF THE DRAWINGS

Implementations of the present disclosure will now be described, by way of embodiments, with reference to the attached figures.

FIG. 1 is a partial isometric view of an embodiment of a bull mill cutter.

FIG. 2 is a side view of the bull mill cutter in FIG. 1.

FIG. 3 is a top view of the bull mill cutter in FIG. 1.

FIG. 4 is a diagram of a first embodiment of a cutter tooth of the bull mill cutter.

FIG. 5 is a diagram of a second embodiment of a cutter tooth of the bull mill cutter.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

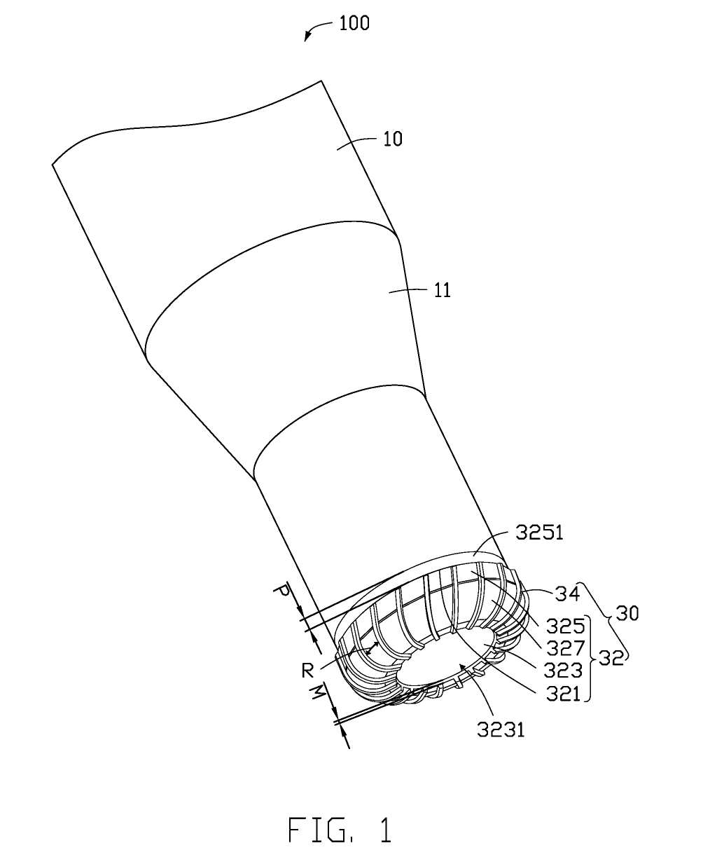

FIGS. 1-3 show an embodiment of a bull mill cutter 100 for processing a work piece. The bull mill cutter 100 includes a cutter bar 10 and a cutter head 30. The cutter head 30 is mounted to an end of the cutter bar 10.

The cutter bar 10 is externally coupled to a processing device (not shown in figures) for driving the bull mill cutter 100 to move and rotate. The cutter bar 10 is substantially cylindrical. In one embodiment, the cutter bar 10 includes a neck portion 11. The neck portion 11 is coupled to the cutter head 30. A diameter of the neck portion 11 coupled to the cutter head 30 is less than a diameter of the cutter bar 10 coupled to the processing device. The cutter bar 10 is made of hard alloy, high-speed steel, or the like. In other embodiments, the cutter bar 10 does not include the neck portion 11 such that the cutter head 30 and the cutter bar 10 have a same diameter.

The cutter head 30 is coupled to the end of the cutter bar 10. The cutter head 30 may be made of diamond, polycrystalline diamond, chemical vapour diamond, microcrystalline diamond, polycrystalline cubic boron nitride, ceramic.

The cutter head 30 includes a main body 32 and a plurality of cutter teeth 34. The main body 32 includes a first end surface 321, a second end surface 323, a side surface 325, and a curved surface 327. The first end surface 321 and the second end surface 323 are oppositely facing each other. The first end surface 321 is coupled to the end of the cutter bar 10. A diameter of the first end surface 321 is greater than a diameter of the second end surface 323. The side surface 325 is coupled to the first end surface 321 and extends around a periphery of the first end surface 321. The side surface 325 is substantially perpendicular to the first end surface 321. The curved surface 327 is arcuately coupled between the side surface 325 and the second end surface 323.

The plurality of cutter teeth 34 are mounted on the main body 32 and extend along the second end surface 323, the curved surface 327, and the side surface 325. A trajectory of each of the cutter teeth 34 on the second end surface 323 points substantially toward a center of the second end surface 323

In one embodiment, the second end surface 323 axially defines a cutting hole 3231. Each of the cutter teeth 34 includes a first end located at a boundary of the cutting hole 3231.

In one embodiment, the side surface 325 defines a cutting groove 3251 extending around a periphery of the side surface 325. Each cutter tooth 34 includes a second end located at a boundary of the cutting groove 3251.

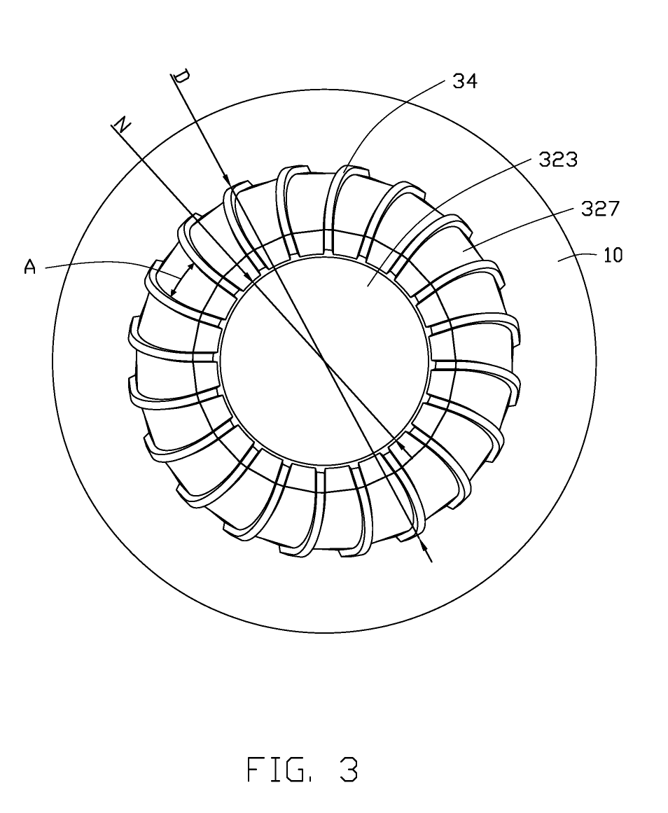

As shown in FIG. 3, a quantity of the plurality of cutter teeth 34 is a positive integer in a range between 8 and D*15 wherein D is a diameter of the main body 32 of the cutter head 30 in millimeters. In one embodiment, the quantity of the plurality of cutter teeth 34 is 20.

Every two adjacent cutter teeth 34 cooperatively define a groove 36. A groove width A of the groove 36 is between 0.01 and 2.0 millimeters. A base of the groove 36 may be a curved surface or may be a flat surface.

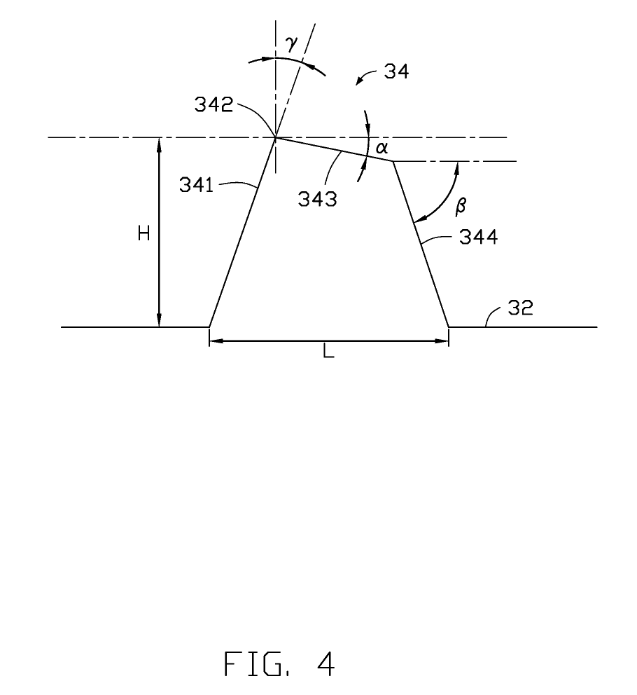

As shown in FIG. 4, each cutter tooth 34 includes a front tooth surface 341, a blade edge 342, a rear tooth surface 343, and a second rear tooth surface 344 connected in sequence. Each of the front tooth surface 341 and the second rear tooth surface 344 is coupled to the main body 32. The blade edge 342 is coupled between the front tooth surface 341 and the rear tooth surface 343 and is opposite the main body 32 and is configured for cutting a workpiece.

In one embodiment, a tooth height H between the blade edge 342 and the main body 32 is between 0.001 millimeters and 0.5 millimeters.

In one embodiment, a cutter tooth width L between the front tooth surface 341 and the second rear tooth surface 344 on the main body 32 is between 0.001 and 1.0 millimeter.

In one embodiment, an anterior angle γ of the front tooth surface 341 relative to a normal plane of the main body 32 is between −40 degrees and 20 degrees.

In one embodiment, a posterior angle a of the rear tooth surface 343 relative to a tangent plane of the blade edge 342 parallel to a tangent plane of the main body 32 is between 0 degrees and 90 degrees.

In one embodiment, a second posterior angle β of the second rear tooth surface 344 relative to a tangent plane of the blade edge 342 parallel to a tangent plane of the main body 32 is between 0 degrees and 90 degrees.

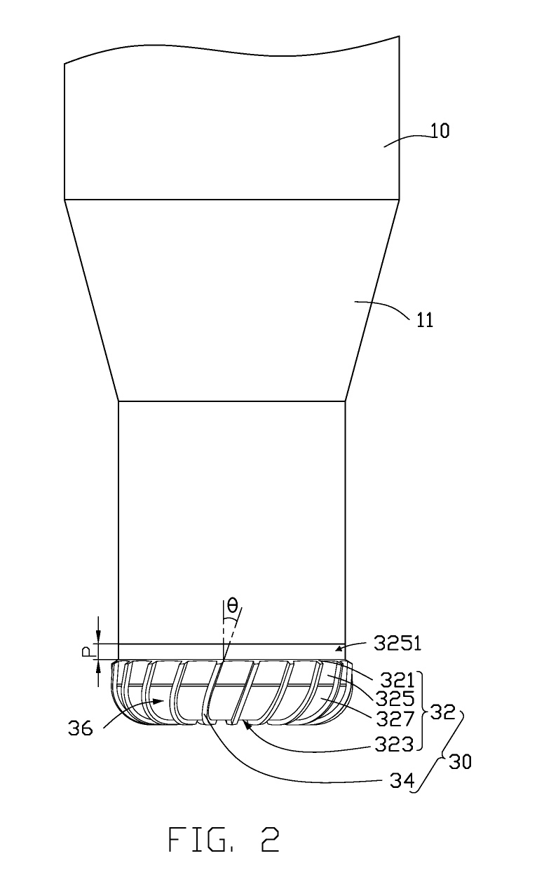

In one embodiment, the cutter teeth 34 are helically arranged on the main body 32. The cutter teeth 34 may be left-helix oriented, right-helix oriented, or a combination of left and right-helix oriented. A helical angle θ of the cutter teeth 34 (shown in FIG. 2) relative to the axis of the cutter bar 10 is between 0 degrees and 90 degrees.

In one embodiment, referring to FIG. 1, the portion of the cutter teeth 34 on the curved surface 327 have a corner radius between 0 and 5.0 mm.

In one embodiment, referring to FIG. 1, the cutting hole 3231 has a depth M between 0.1 and 3.0 mm.

As shown in FIG. 3, a diameter N of the cutting hole 3231 is between 0.1*D and 0.9*D.

In one embodiment, the cutting groove 3251 has a depth between 0.001 and 1.0 mm.

In one embodiment, the second cutting groove 3251 has a width P between 0.1 and 2.0 mm.

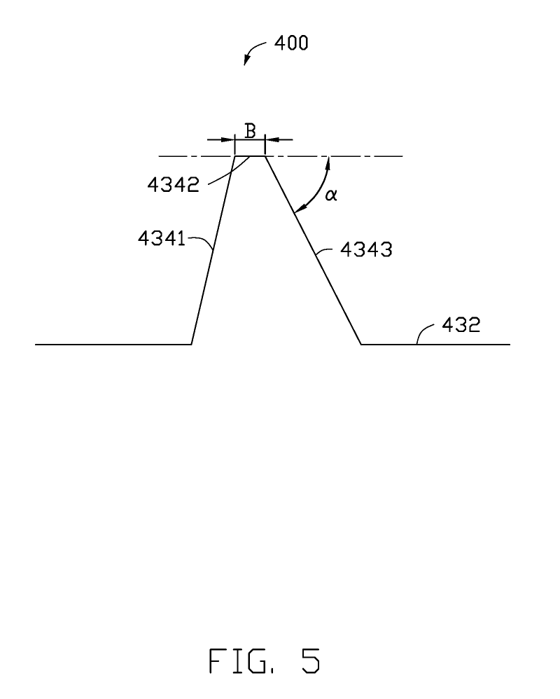

FIG. 5 shows a second embodiment of a bull mill cutter 400. A difference between the second embodiment and the first embodiment is that a plurality of cutter teeth 434 of the bull mill cutter 400 include a front tooth surface 4341, a blade edge 4342, and a rear tooth surface 4343 connected in sequence. Each of a front tooth surface 4341 and a rear tooth surface 4343 is coupled to a main body 432.

In one embodiment, a blade width B of the blade edge 4342 is between 0 and 0.1 millimeter.

The posterior angle α is between 0 degrees and 90 degrees.

The bull mill cutter 100/400 as described above include the main body 32/432 mounting the plurality of cutter teeth 34/434. The quantity of the plurality of cutter teeth 34/434 is equal to a positive integer in a range between 8 and D*15 wherein D is equal to the diameter of the main body 32 in millimeters. Thus, the bull mill cutter 100/400 can precisely process a workpiece such as graphite, ceramic, or other hard material, thereby enhancing a feed rate and an efficiency of processing workpieces. Furthermore, a life of the bull mill cutter 100/400 is extended.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A bull mill cutter comprising:
a cutter bar; and
a cutter head, one end of the cutter head being mounted to the cutter bar, the cutter head comprising:
a main body; and
a plurality of cutter teeth mounted on the main body, a quantity of the plurality of cutter teeth equal to a positive integer within a range from 8 to D multiply by 15, wherein D is equal to a diameter of the main body of the cutter head in millimeters.

2. The bull mill cutter of claim 1, wherein:
the main body comprises a first end surface, a second end surface, a side surface, and a curved surface;
the first end surface is coupled to the cutter bar, the second end surface is opposite to the first end surface, the side surface is coupled perpendicularly to the first end surface, and the curved surface is coupled between the side surface and the second end surface;
each of the plurality of cutter teeth extends along the side surface, the curved surface, and the second end surface.

3. The bull mill cutter of claim 2, wherein the cutter head is made of diamond, cubic boron nitride, ceramic, or hard alloy.

4. The bull mill cutter of claim 3, wherein;
the second end surface defines a cutting hole; and
each of the plurality of cutter teeth has a first end located at a periphery of the cutting hole.

5. The bull mill cutter of claim 4, wherein:
the side surface defines a cutting groove extending along a circumference of the side surface; and
a second end opposite to the first end of each of the plurality of cutter teeth is located at a periphery of the cutting groove.

6. The bull mill cutter of claim 5, wherein:
the cutting hole is round; and
a diameter of the cutting hole is a value within a range from 0.1 multiply by D to 0.9 multiply by D.

7. The bull mill cutter of claim 6, wherein:
each of the plurality of cutter teeth comprises a blade edge; and
a shortest distance between the blade edge and the main body is between 0.001 and 0.5 millimeters.

8. The bull mill cutter of claim 7, wherein a width of the blade edge is between 0 and 0.1 millimeters.

9. The bull mill cutter of claim 8, wherein:
each of the plurality of cutter teeth comprises a front tooth surface; and
an anterior angle of the front tooth surface relative to a normal plane of the main body is between −40 degrees and 20 degrees.

10. The bull mill cutter of claim 9, wherein:
each of the plurality of cutter teeth comprises a rear tooth surface; and
a posterior angle of the rear tooth surface relative to a tangent plane of the blade edge parallel to tangent plane of the main body is between 0 degrees and 90 degrees.

11. The bull mill cutter of claim 10, wherein every adjacent two of the plurality of cutter teeth cooperatively define a groove, having a width of the groove being between 0.01 and 2.0 millimeters.

12. The bull mill cutter of claim 11, wherein:
the front tooth surface, the blade edge, and the rear tooth surface are coupled in sequence;
each of the front tooth surface and the rear tooth surface is coupled to the main body;
the blade edge is coupled between the front tooth surface and the rear tooth surface and is opposite the main body.

13. The bull mill cutter of claim 11, wherein:
each of the plurality of cutter teeth comprises a second tooth surface;
the front tooth surface, the blade edge, the rear tooth surface, and the second rear tooth surface are coupled in sequence;
each of the front tooth surface and the second rear tooth surface is coupled to the main body;
the blade edge is coupled between the front tooth surface and the first rear tooth surface and is opposite the main body.
